(19) United States
(12) Patent Application Publication
(10) Pub. No.: US 2020/0332809 A1
(43) Pub. Date: Oct. 22, 2020

(54) PORTABLE COOLING APPARATUS

(71) Applicant: Kenn Stephen BUXTON, North Vancouver (CA)

(72) Inventor: Kenn Stephen BUXTON, North Vancouver (CA)

(21) Appl. No.: 16/850,676

(22) Filed: Apr. 16, 2020

Related U.S. Application Data
(60) Provisional application No. 62/834,908, filed on Apr. 16, 2019.

(51) Int. Cl. F04D 29/62; F04D 17/08

(52) U.S. Cl. CPC F04D 29/626; F05B 2240/90; F04D 17/08

(57) ABSTRACT

A portable cooling apparatus comprises a fan unit and a holder. The fan unit comprises a housing, a fan, a plurality of intake openings, and a plurality of outflow openings. The housing comprising a first housing surface. The fan is located within the housing and is adapted to circulate air. The intake openings are located on the first housing surface, with the intake openings adapted to allow air to enter into the housing for circulation by the fan. The outflow openings located on the housing, with the outflow openings adapted to allow air to exit from the housing. The holder comprises a backing, one or more walls, and a protrusion. The backing comprises a first backing surface. The walls extend from the backing. The protrusion is located on the first backing surface. The fan unit is adapted to engage within the holder, and when so engaged, the first housing surface is spaced apart from the backing by the protrusion.

### CROSS-REFERENCE TO RELATED APPLICATIONS

This application claims the benefit of U.S. Provisional Patent Application No. 62/834,908 filed Apr. 16, 2019, the contents of which are hereby incorporated by reference.

### FIELD OF THE INVENTION

The invention relates to portable cooling systems, and in particular, a portable cooling system that can be attached to a person's clothing.

### BACKGROUND OF THE INVENTION

Portable cooling systems are known. For example, various hand-held fan systems are available. However, these systems typically require that a person hold on to the fan at all times, making them inconvenient for extended use.

For example, one area of the body that may potentially require cooling for extended periods of time is the groin area. Testicles are the primary male reproductive gland in humans, and its functions include the production of sperm. The production of sperm is enhanced at temperatures that are slightly less than normal human body temperatures. Because the testicles are located outside of the body (within the scrotum), this facilitates a lower temperature for the testicles compared to normal body temperature.

However, certain environmental and non-environmental factors may affect the temperature of the testicles. These include factors such as the weather, the health of the person, the person's clothing, and the person's activity level. If these factors cause the temperature of the testicles to increase, sperm production may be impaired.

In addition to the groin area, other areas of the body may also benefit from extended cooling (e.g. the torso). There is therefore a need for a convenient and effective portable cooling system that can be attached to a person's clothing so that it does not need to held for extended periods of time.

### SUMMARY OF THE INVENTION

A portable cooling apparatus comprises a holder and a fan unit. The holder comprises a clip and a backing with vent openings. A plurality of walls extends from the backing. The fan unit comprises an internal fan housed within a housing. The housing has opposed first and second housing surfaces, with intake openings on the first housing surface. Air outflow openings may be present on one end of the housing. The fan may be battery-operated and is able to circulate air from the intake openings through the outflow openings to produce a cooling effect. The fan unit may be inserted into the holder in different orientations, depending on the desired direction of air flow.

In one embodiment of the invention, a portable cooling apparatus comprises a fan unit and a holder. The fan unit comprises a housing, a fan, a plurality of intake openings, and a plurality of outflow openings. The housing comprising a first housing surface. The fan is located within the housing and is adapted to circulate air. The intake openings are located on the first housing surface, with the intake openings adapted to allow air to enter into the housing for circulation by the fan. The outflow openings located on the housing, with the outflow openings adapted to allow air to exit from the housing. The holder comprises a backing, one or more walls, and a protrusion. The backing comprises a first backing surface. The walls extend from the backing. The protrusion is located on the first backing surface. The fan unit is adapted to engage within the holder. When the fan unit is engaged within the holder, the first housing surface is spaced apart from the backing by the protrusion.

In another embodiment of the invention, the backing further comprises a backing upper edge, and the protrusion is located proximate to the backing upper edge.

In yet another embodiment of the invention, the holder further comprises a clip extending proximate to the backing upper edge.

In still yet another embodiment of the invention, the clip extends from the protrusion.

In still a further embodiment of the invention, the clip comprises first and second clip portions. The curved first clip portion extends proximate to the backing upper edge while the substantially planar second slip portion is connected to the first clip portion.

In yet a further embodiment of the invention, one or more of the walls comprise wall openings.

In another embodiment of the invention, the fan unit further comprises a power supply located within the housing for powering the fan.

In still another embodiment of the invention, the fan unit comprises a power switch located on the housing for controlling operation of the fan.

In still yet another embodiment of the invention, the housing comprises a first housing end, with the outflow openings located on the first housing end.

In yet another embodiment of the invention, the holder further comprises a retaining arm extending proximate to the backing upper edge, with the retaining arm adapted to engage with the fan unit.

In still yet another embodiment of the invention, the retaining arm extends from the protrusion.

In a further embodiment of the invention, the retaining arm comprises an angled end.

In still a further embodiment of the invention, the fan unit comprises first and second housing ends, with the retaining arm adapted to engage with one of the first and second housing ends.

In yet still a further embodiment of the invention, the fan unit further comprises a lanyard extending from the housing.

In another embodiment of the invention, the backing comprises a plurality of vent openings adapted to allow air to pass therethrough.

In yet another embodiment of the invention, the first housing surface is spaced between 0.125 and 0.25 inches from the backing.

The foregoing was intended as a summary only and of only some of the aspects of the invention. It was not intended to define the limits or requirements of the invention. Other aspects of the invention will be appreciated by reference to the detailed description of the embodiments.

### BRIEF DESCRIPTION OF THE DRAWINGS

The preferred embodiment of the invention will be described by reference to the drawings thereof, in which:

FIG. 1 is a front perspective view of the portable cooling apparatus in accordance with one embodiment of the invention;

FIG. 2 is a rear perspective view of the portable cooling apparatus of FIG. 1;

FIG. 3 is another front perspective view of the portable cooling apparatus of FIG. 1;

FIG. 4 is another rear perspective view of the portable cooling apparatus of FIG. 1;

FIG. 5 is a top view of the portable cooling apparatus of FIG. 1;

FIG. 6 is a bottom view of the portable cooling apparatus of FIG. 1;

FIG. 7 is a front view of the portable cooling apparatus of FIG. 1;

FIG. 8 is a side view of the portable cooling apparatus of FIG. 1;

FIG. 9 is a rear view of the portable cooling apparatus of FIG. 1;

FIG. 10 is a front perspective view of the holder of the portable cooling apparatus;

FIG. 11 is a rear perspective view of the holder of FIG. 10;

FIG. 12 is a top view of the holder of FIG. 10;

FIG. 13 is a bottom view of the holder of FIG. 10;

FIG. 14 is a front view of the holder of FIG. 10;

FIG. 15 is a side view of the holder of FIG. 10;

FIG. 16 is a rear view of the holder of FIG. 10;

FIG. 17 is a front perspective view of the fan unit of the portable cooling apparatus;

FIG. 18 is a front perspective view of another embodiment of the fan unit of the portable cooling apparatus;

FIG. 19 is a rear perspective view of the fan unit of FIG. 18;

FIG. 20 is a front view of the fan unit of FIG. 18;

FIG. 21 is a side view of the fan unit of FIG. 18;

FIG. 22 is a rear view of the fan unit of FIG. 18;

FIG. 23 is a front perspective view showing the portable cooling apparatus with the fan unit being inserted into the holder;

FIG. 24 is a front perspective view showing the portable cooling apparatus with the fan unit inserted into the holder;

FIG. 25 is a rear perspective view showing the portable cooling apparatus with the fan unit being inserted into the holder;

FIG. 26 is a rear perspective view showing the portable cooling apparatus with the fan unit inserted into the holder;

FIG. 27 is a side view showing the portable cooling apparatus with the fan unit inserted into the holder;

FIG. 28 is a front perspective view showing the portable cooling apparatus with the fan unit being inserted into the holder in a different orientation;

FIG. 29 is a front perspective view showing the portable cooling apparatus with the fan unit inserted into the holder in the orientation of FIG. 28;

FIG. 30 is a rear perspective view showing the portable cooling apparatus with the fan unit being inserted into the holder in the orientation of FIG. 28;

FIG. 31 is a rear perspective view showing the portable cooling apparatus with the fan unit inserted into the holder in the orientation of FIG. 28;

FIG. 32 is a side view showing the portable cooling apparatus with the fan unit inserted into the holder in the orientation of FIG. 28;

FIG. 33 shows one orientation of the portable cooling apparatus; and

FIG. 34 shows a second orientation of the portable cooling apparatus of FIG. 33.

### DETAILED DESCRIPTION

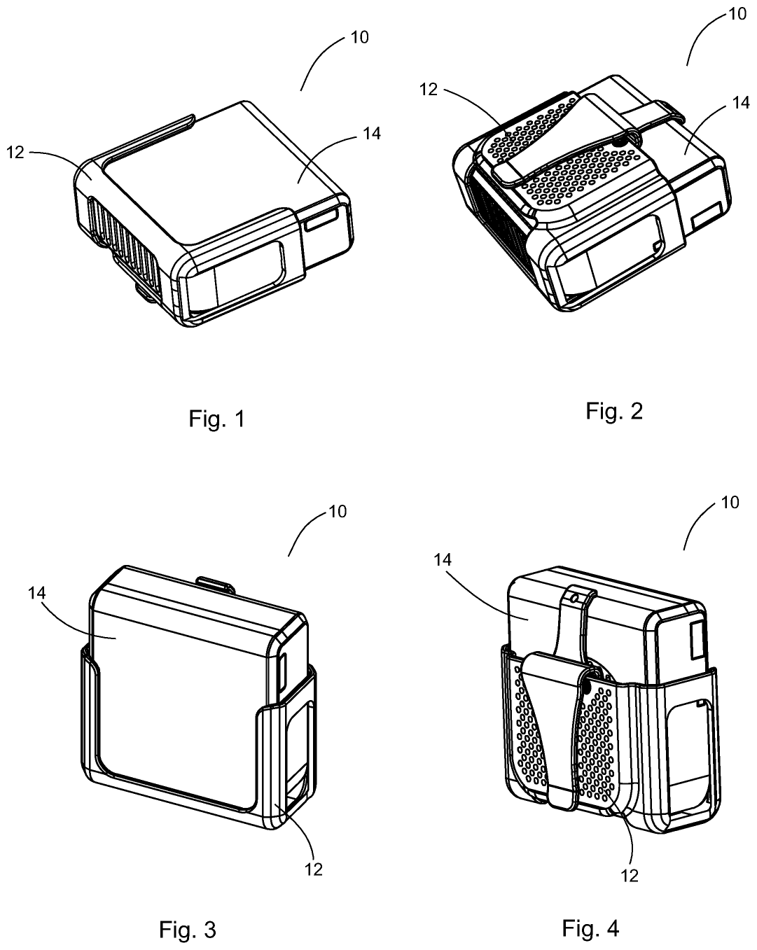

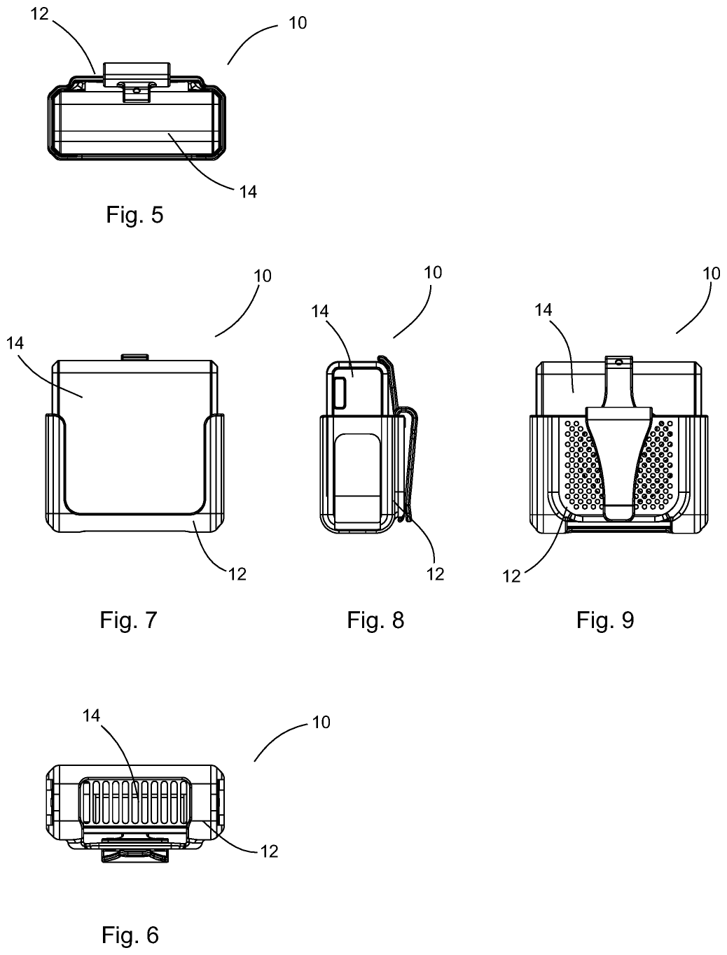

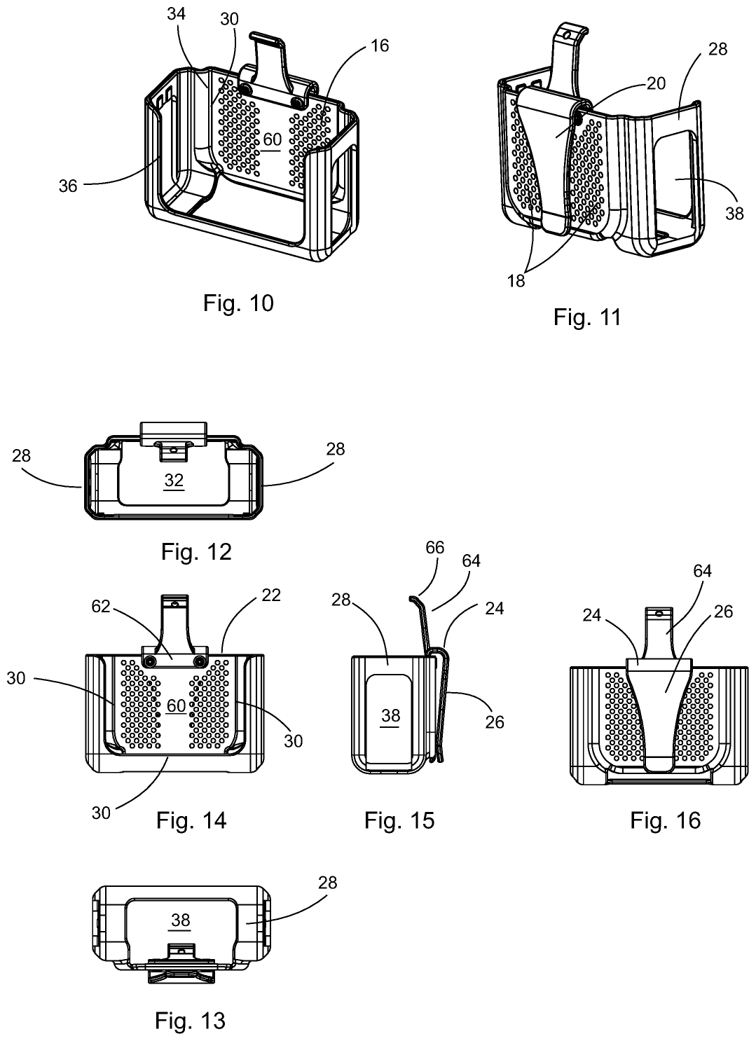

Referring to Figs.1 to 9, a portable cooling apparatus 10 in accordance with the invention comprises a holder 12 and a fan unit 14, with the fan unit 14 adapted to removably attach to the holder 12. Referring to FIGS. 10 to 16, the holder 12 comprises a substantially planar backing 16 with a plurality of vent openings 18 formed therethrough. In the embodiment shown in FIGS. 10 to 16, the backing 16 has a generally rectangular shape, although other shapes are also possible. A clip 20 extends proximate to a backing upper edge 22 of the backing 16. Preferably, the clip 20 comprises a curved first clip portion 24 and a substantially planar second clip portion 26. The first clip portion 24 is connected to the backing 16 and initially extends away from the backing 16 before curving back towards the backing 16. The second clip portion 26 extends from the first clip portion 24 and extends generally over the backing 16.

The holder 12 is adapted to engage with a conventional belt by fitting the belt between the clip 20 and the backing 16. Preferably, the first clip portion 24 is adapted to engage with the upper edge of the belt, with the backing 16 and the second clip portion 26 on opposing sides of the belt, thereby securing the holder 12 in place with respect to the belt. Alternatively, the clip 20 and the backing 16 may be adapted to engage with the waistband for clothing, such as the waistband for pants or underwear.

Referring to FIGS. 10 and 11, one or more walls 28 extend from the backing 16. The walls 28 assist in holding in place the fan unit 14. In the embodiment shown in FIGS. 10 to 16, the walls 28 extend generally from backing edges 30 of the backing 16, except for the backing upper edge 22. In other words, the walls 28 extend from three backing edges 30. The absence of wall 28 extending from the backing upper edge 22 provides for an upper opening 32 for insertion and removal of the fan unit 14. Preferably, the walls 28 comprise opposing first and second wall edges 34, 36, with the first wall edge 34 being connected to one of the backing edges 30. The portions of the walls 28 proximate to the first and second wall edges 34, 36 being curved, as best shown in FIGS. 10 and 11. The curvature of the walls 28, especially proximate to the second wall edges 36, assist in securing the fan unit 14 within the holder 12 by wrapping around the fan unit 14.

The walls 28 may also comprise one or more wall openings 38, which provide access to the fan unit 14 when the fan unit 14 is located within the holder 12.

In accordance with one embodiment, the holder 12 is approximately 3 inches wide and approximately 3.5 inches tall and approximately 1.5 inches deep. It is understood that other dimensions are also possible.

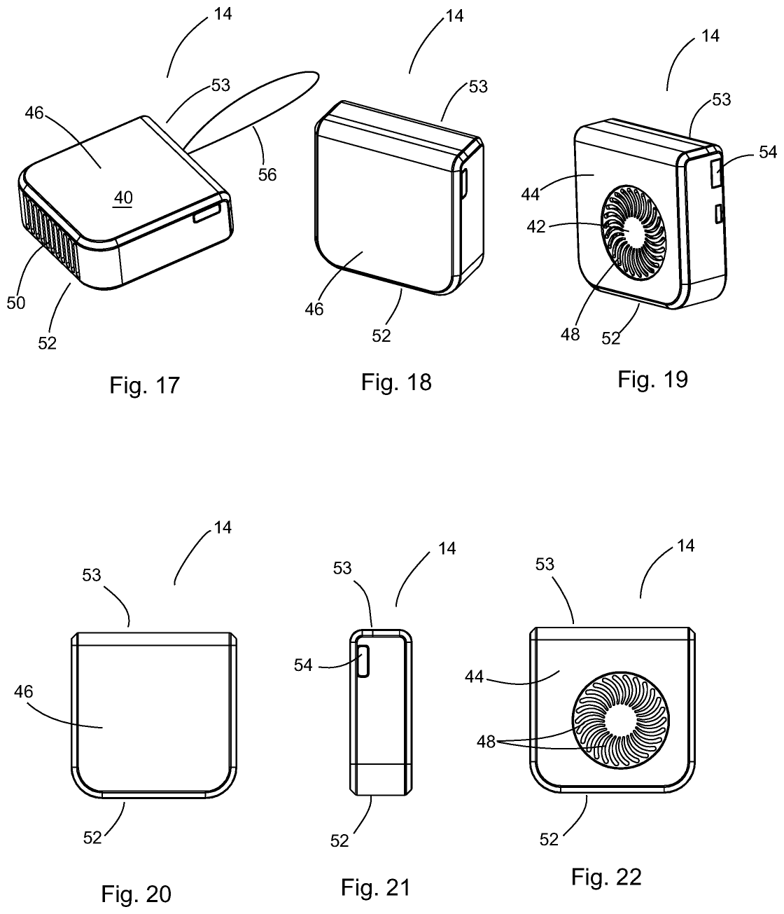

Referring to FIGS. 17 to 22, the fan unit 14 comprises an outer housing 40 containing an internal fan 42. The fan 42 may be powered by a power supply such as a battery (not shown) located within the housing 40. In the embodiment shown in FIGS. 17 to 22, the housing is generally shaped in the form of a rectangular box, but other shapes are also possible. Rotation of the fan 42 within the housing 40 allows for the circulation and movement of air, thereby producing a cooling effect.

The housing 40 comprises opposed first and second housing surfaces 44, 46 and first and second housing ends 52, 53. The first housing surface 44 comprises a plurality of intake openings 48 to allow for air flow into the fan 42. The housing 40 also comprises a plurality of outflow openings 50 for allowing the flow of air away from the fan 42. In the embodiment shown in FIGS. 17 to 22, the outflow openings 50 are located on or proximate to the first housing end 52 of the housing 40. In this embodiment, the intake openings 48 and the outflow openings 50 would be oriented substantially perpendicularly to each other.

The fan unit 14 may comprise a power switch 54 for controlling the operation of the fan 42. The power switch 54 may be a pushbutton switch, a toggle switch, or the like. The power switch 54 may be located on the first or second housing surfaces 44, 46 or on some other surface of the housing 40.

In accordance with one embodiment, the fan unit 14 is approximately 2.75 inches wide and approximately 4.6 inches tall and approximately 1.1 inches deep. It is understood that other dimensions are also possible, so long as the fan unit 14 is able to fit within the holder 12. The fan unit 14 may also comprise a lanyard 56 extending from the housing 40. The lanyard 56 may be placed around the neck of a user 58 to allow the fan unit 14 to be suspended from the neck.

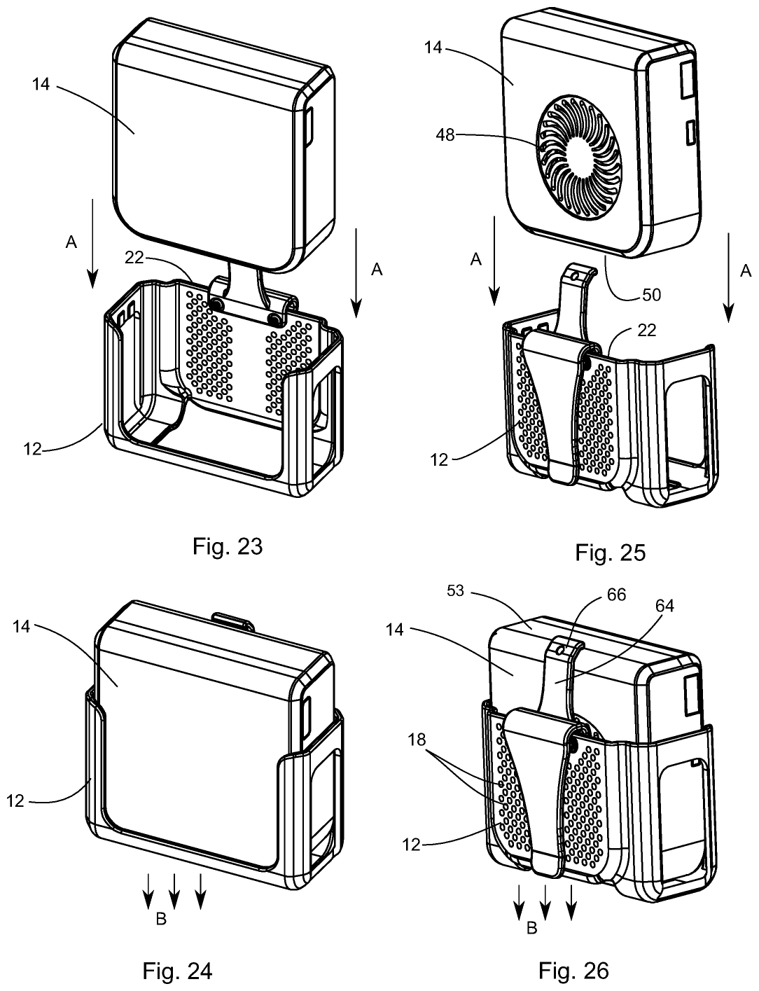

Referring to FIGS. 23 to 32, the fan unit 14 may be inserted into the holder 12 in a number of orientations. Referring to FIGS. 23 to 27, the fan unit 14 is inserted in the holder 12 (in direction A) such that the outflow openings 50 are oriented away from the backing upper edge 22. In this orientation, the outflow openings 50 correspond to the wall opening 38 such that air flow out of the outflow openings 50 is not impeded by the wall 28. This would allow (cooler) air to flow out of the outflow openings 50 and through the wall opening 38 away from the fan 42 (in direction B). Air would also be able to enter the fan unit 14 through the intake openings 48. Since, in this orientation, the intake openings 48 are facing the backing 16, a portion of the air entering the fan unit 14 may also pass through the vent openings 18.

Preferably, when the fan unit 14 is inserted into the holder 12 in this orientation, the backing 16 is spaced apart from the first housing surface 44 (forming a separation 68) so as to not completely impede the flow of air into the fan unit 14 through the intake openings 48. For example, when the holder 12 is attached to the user 58 (such as through a belt), the backing 16 may be in contact with the clothing of the user 58. This clothing may block the vent openings 18, thereby preventing any air flow through the vent openings 18. If the first housing surface 44 was in direct contact with the backing 16, then the blockage of the vent openings 18 by clothing would completely impede air flow through the intake openings 48. However, by maintaining the separation 68 between the backing 16 and the first housing surface 44, even if the vent openings 18 were blocked (e.g. by clothing), there would still be some air flow possible through the intake openings 48 through the separation 68 (i.e. from above, proximate to the backing upper edge 22). In one embodiment of the invention, the separation 68 or gap between the backing 16 and the first housing surface 44 may be between 0.125 and 0.25 inches.

The separation 68 between the backing 16 and the first housing surface 44 may be achieved in a number of ways. For example, the curvature of the walls 28 proximate to the first wall edges 34 may force the first housing surface 44 away from the backing 16. Alternatively, or in addition, a protrusion 62 may be located on a first backing surface 60 of the backing 16. The protrusion 62 serves to force the first housing surface 44 away from the first backing surface 60 thereby creating the separation 68 between the first housing surface 44 and the backing 16.

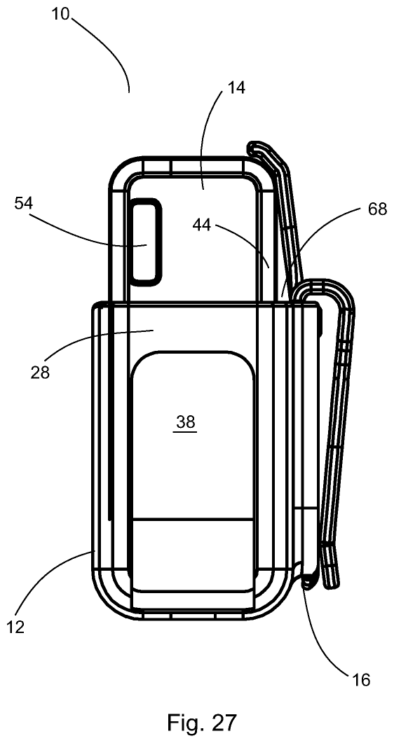

In the embodiment shown in FIGS. 23 to 26, the protrusion 62 is located proximate to the backing upper edge 22 and is connected to the first clip portion 24. Preferably, a retaining arm 64 extends from the protrusion 62 and away from the backing upper edge 22. The retaining arm 64 assists in holding the fan unit 14 in place within the holder 12 by engaging with one of the first housing end 52 or the second housing end 53. For example, when the fan unit 14 is inserted into the holder 12 in the orientation shown in FIGS. 23 to 26, the retaining arm 64 will engage with the second housing end 53. The retaining arm 64 may comprise an angled end 66 for engagement with the first housing end 52 or the second housing end 53. In addition, the retaining arm 64 may also assist in maintaining the separation 68 between the first housing surface 44 and the backing 16, as best shown in FIG. 27.

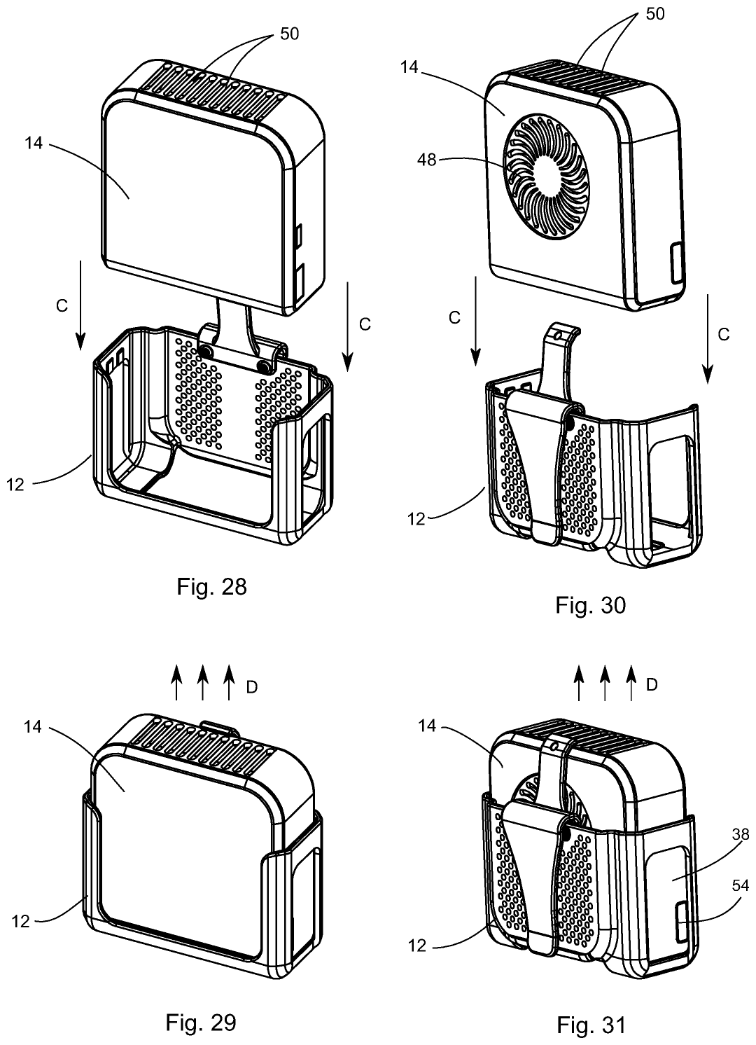

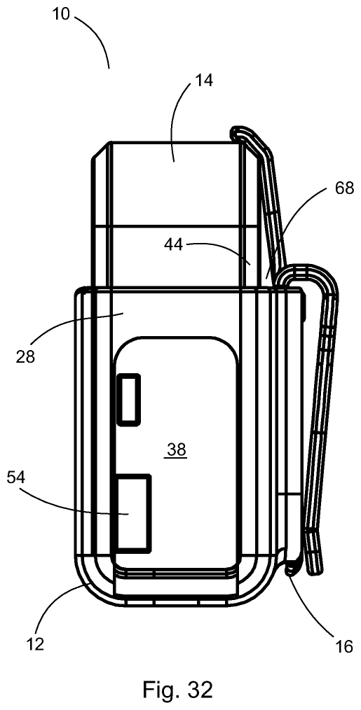

Referring to FIGS. 28 to 32, the fan unit 14 is inserted into the holder 12 in an opposite direction than in FIGS. 23 to 27 (i.e. direction C). In this orientation, the outflow openings 50 would be facing generally upwards after insertion of the fan unit 14 into the holder 12. As a result, the (cooler) air flow would be directed in a generally upwards direction (in direction D). In this orientation, the separation 68 between the first housing surface 44 and the backing 16 is still present, as best shown in FIG. 32.

Referring to FIG. 32, when the fan unit 14 is inserted into the holder 12, the wall openings 38 allow for accessing the fan unit 14, such as accessing the power switch 54.

In another embodiment, the protrusion 62 may be located at other locations (besides proximate to the backing upper edge 22) on the first backing surface 60.

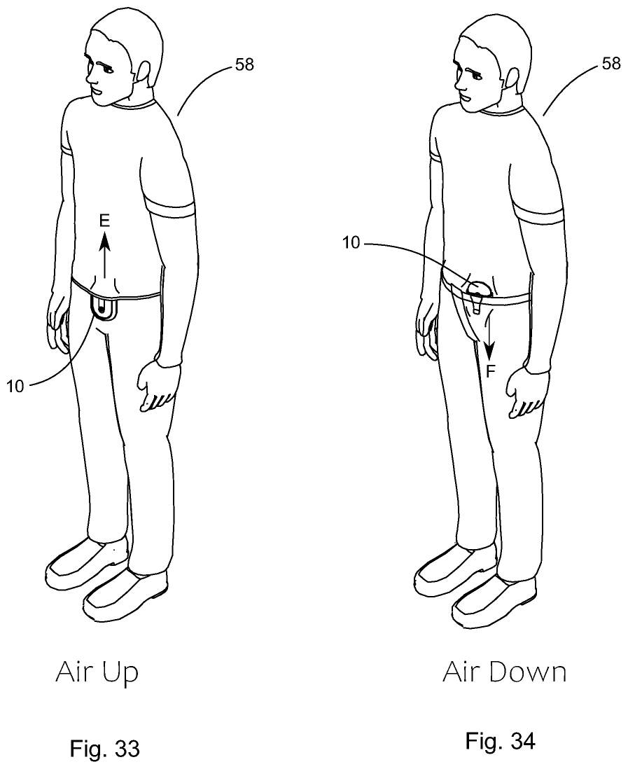

Referring to FIGS. 33 to 34, when the portable cooling apparatus 10 is used by the user 58, the portable cooling apparatus 10 may be placed in a number of orientations. For example, FIG. 33 shows an embodiment in which the portable cooling apparatus 10 is oriented such that the second housing surface 46 of the housing 40 is facing outwards from the user 58. In this orientation, the holder 12 is oriented such that the backing 16 of the holder 12 is next to the user 58. In addition, the outflow openings 50 are directed in a generally upwards direction, meaning that the (cooler) air flow from the fan 42 would be directed generally upwards (i.e. in direction E). This allows the user 58 to experience a cooling effect for the portion of the body above the waist. As shown in FIG. 33, the portable cooling apparatus 10 may be placed partially under clothing so that the air flow from the fan 42 circulates between the clothing and the skin of the user 58.

In contrast, FIG. 34 shows another embodiment in which the portable cooling apparatus 10 is oriented in a different manner. In this embodiment, the clip 20 and the backing 16 are facing away from the user 58 (i.e. the fan unit 14 is between the user 58 and the backing 16). In addition, the outflow openings 50 are directed in a generally downwards direction, meaning that the (cooler) air flow from the fan 42 would be directed generally downwards (i.e. in direction F). This allows the user 58 to experience a cooling effect for the portion of the body below the waist (e.g. the groin area). As shown in FIG. 34, the portable cooling apparatus 10 may be placed partially under clothing so that the air flow from the fan 42 circulates between the clothing and the skin of the user 58.

By attaching the portable cooling apparatus 10 to the user 58, the portable cooling apparatus 10 is able to direct cooler air to the user 58. In particular, if the portable cooling apparatus 10 is attached to the waistband of the clothing of the user 58, the cooler air may be directed in either an upwards or downwards direction, providing a cooling effect for regions above or below the waist, respectively.

It will be appreciated by those skilled in the art that the preferred embodiment has been described in some detail but that certain modifications may be practiced without departing from the principles of the invention.

1. A portable cooling apparatus comprising:
a fan unit comprising:
a housing comprising a first housing surface;
a fan located within the housing, wherein the fan is adapted to circulate air;
a plurality of intake openings located on the first housing surface, wherein the intake openings are adapted to allow air to enter into the housing for circulation by the fan; and
a plurality of outflow openings located on the housing, wherein the outflow openings are adapted to allow air to exit from the housing; and
a holder comprising:
a backing comprising a first backing surface;
one or more walls extending from the backing; and
a protrusion on the first backing surface;
wherein the fan unit is adapted to engage within the holder; and
wherein when the fan unit is engaged within the holder, the first housing surface is spaced apart from the backing by the protrusion.

2. The portable cooling apparatus of claim 1, wherein the backing further comprises a backing upper edge, and wherein the protrusion is located proximate to the backing upper edge.

3. The portable cooling apparatus of claim 2, wherein the holder further comprises a clip extending proximate to the backing upper edge.

4. The portable cooling apparatus of claim 3, wherein the clip extends from the protrusion.

5. The portable cooling apparatus of claim 4, wherein the clip comprises:
a curved first clip portion extending proximate to the backing upper edge; and
a substantially planar second slip portion connected to the first clip portion.

6. The portable cooling apparatus of claim 1, wherein one or more of the walls comprise wall openings.

7. The portable cooling apparatus of claim 1, wherein the fan unit further comprises a power supply located within the housing for powering the fan.

8. The portable cooling apparatus of claim 7, wherein the fan unit comprises a power switch located on the housing for controlling operation of the fan.

9. The portable cooling apparatus of claim 1, wherein the housing comprises a first housing end, wherein the outflow openings are located on the first housing end.

10. The portable cooling apparatus of claim 2, wherein the holder further comprises a retaining arm extending proximate to the backing upper edge, and wherein the retaining arm is adapted to engage with the fan unit.

11. The portable cooling apparatus of claim 10, wherein the retaining arm extends from the protrusion.

12. The portable cooling apparatus of claim 11, wherein the retaining arm comprises an angled end.

13. The portable cooling apparatus of claim 12, wherein the fan unit comprises first and second housing ends, and wherein the retaining arm is adapted to engage with one of the first and second housing ends.

14. The portable cooling apparatus of claim 1, wherein the fan unit further comprises a lanyard extending from the housing.

15. The portable cooling apparatus of claim 1, wherein the backing comprises a plurality of vent openings adapted to allow air to pass therethrough.

16. The portable cooling apparatus of claim 1, wherein the first housing surface is spaced between 0.125 and 0.25 inches from the backing.
